(19) United States
(12) Patent Application Publication
(10) Pub. No.: US 2016/0380395 A1
(43) Pub. Date: Dec. 29, 2016

(54) REELING DEVICE

(71) Applicant: Rich Electric Wire and Cable Co. Ltd., Yunlin County (TW)

(72) Inventor: Chang-Chi LEE, Yunlin County (TW)

(21) Appl. No.: 14/747,569

(22) Filed: Jun. 23, 2015

(51) Int. Cl. H01R 13/72; H02J 50/10; B65H 75/36

(52) U.S. Cl. CPC H01R 13/72; B65H 75/364; H02J 50/10; B65H 2701/34

(57) ABSTRACT

A reeling device includes a reeling member, a connecting cable, two connectors, a case, and a wireless power transmission module. The connecting cable winds around the reeling member. The connectors are respectively connected to two ends of the connecting cable. The reeling member is provided in the case, wherein the two ends of the connecting cable respectively extends out of the case through two openings of the case. The wireless power transmission module is provided in the case, including an induction coil and a conversion circuit, wherein the conversion circuit is electrically connected to the induction coil and the connecting cable respectively. Whereby, the reeling device not only can be used as an extension cord for signals or power, but also can transmit power wirelessly.

### BACKGROUND OF THE INVENTION

1. Technical Field

The present invention relates generally to organizing electrical connection cables, and more particularly to a reeling device capable of transmitting power wirelessly.

2. Description of Related Art

A conventional cable reel includes a reeling member, a connecting cable, and two connectors, wherein the connecting cable winds around the reeling member, and the two connectors are respectively connected at two ends of the connecting cable. The connecting cable can be pulled out of the reeling member, and automatically sprung back into the reeling member when no force is exerted thereon. Therefore, a conventional cable reel can organize its connecting cable properly and neatly.

While a conventional cable reel is used to transmit power, one of the connectors is connected to a power source, and the other connector is connected to an electrical device (e.g., a mobile phone) which requires power. However, a conventional cable reel can only transmit power through physical connections, and is not capable of providing such function in a wireless way. In this sense, the usage of a conventional cable reel is limited.

### BRIEF SUMMARY OF THE INVENTION

In view of the above, the primary objective of the present invention is to provide a reeling device, which is capable of transmitting power wirelessly.

The present invention provides a reeling device, which includes a reeling member, a connecting cable, a first connector, a second connector, a case, and a wireless power transmission module. The connecting cable winds around the reeling member. Two ends of the connecting cable are electrically connected to one of the first connector and the second connector respectively. The case has an opening communicating an inside thereof, wherein the reeling member is received in the case, and one of the ends of the connecting cable extends out of the case through the opening by exerting a pulling force. The wireless power transmission module comprises an induction coil and a conversion circuit, wherein the induction coil is provided in the case, and the conversion circuit is electrically connected to the induction coil and the connecting cable respectively.

The reeling device provided in the present invention combines the functions of a conventional cable reel and a wireless charging module, and therefore not only can be used as an extension cord for signals or power, but also can transmit power wirelessly, which makes the reeling device versatile in its usage.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a first preferred embodiment of the present invention;

FIG. 2 is a exploded view of the first preferred embodiment of the present invention;

FIG. 3 is a schematic diagram of the first preferred embodiment of the present invention; and

FIG. 4 is a schematic diagram of a second preferred embodiment of the present invention.

### DETAILED DESCRIPTION OF THE INVENTION

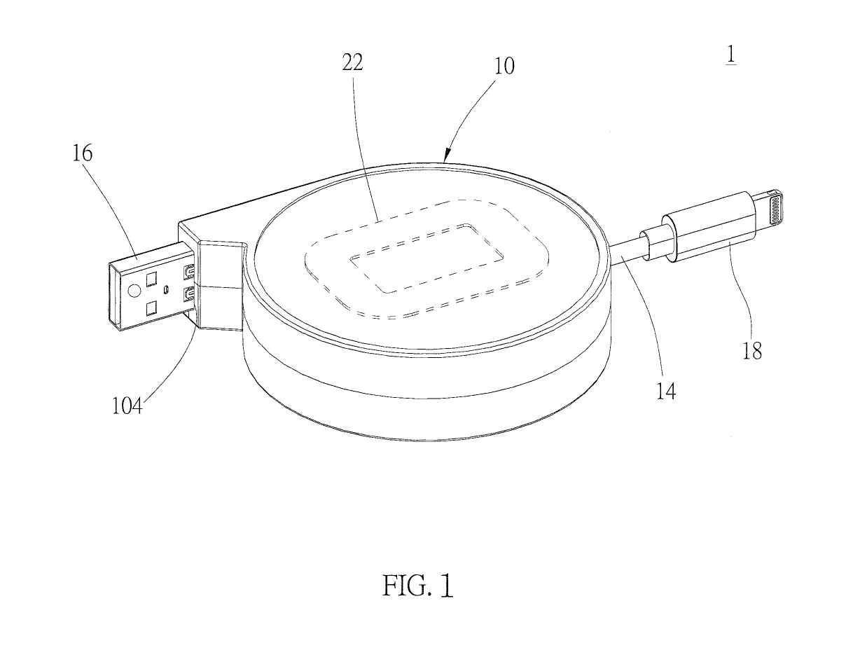

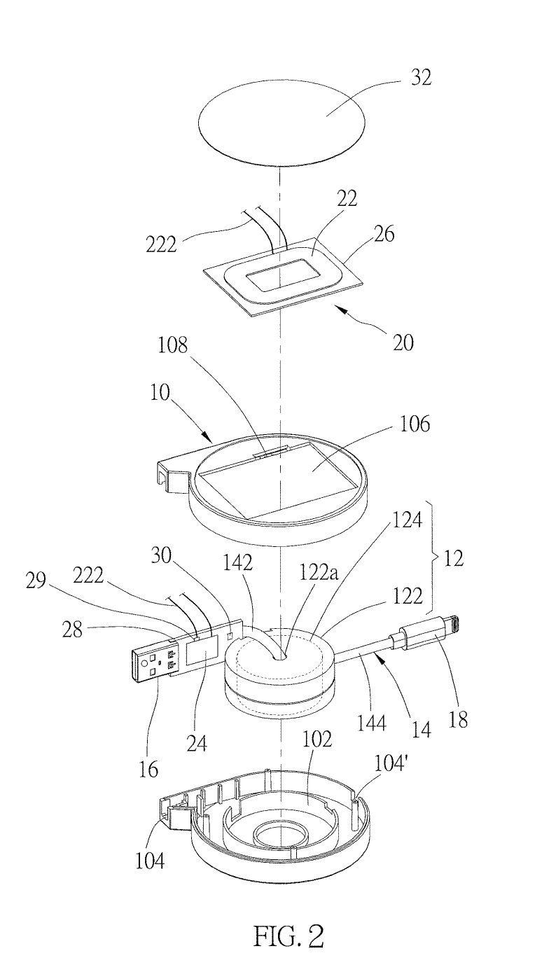

As shown in FIG. 1 to FIG. 3, a reeling device 1 of the first preferred embodiment of the present invention includes a case 10, a reel 12, a connecting cable 14, a first connector 16, a second connector 18, and a wireless power transmission module 20.

The case 10 is cylindrical, and is formed by two corresponding half casings. The case 10 has a cavity 102 and two openings 104, 104′, wherein the openings 104, 104′ communicate with the cavity 102 and the outside of the case 10. In addition, a rectangular recess 106 is formed on an external surface of the case 10, wherein a side of the recess 106 has a long perforation 108, which communicates the recess 106 and the cavity 102 inside the case 10.

The reel 12 is received in the cavity 102, including a housing 122 and a reeling member 124. The housing 122 is cylindrical, and has a plane facing the perforation 108 of the case 10, wherein the plane has a bore 122a at a center thereof to communicate with the inside of the housing 122. The reeling member 124 is located inside the housing 122 to organize the connecting cable 14 therein, wherein the design of the reeling member 124 is common knowledge in the art, which typically includes a volute spiral spring, a coiling drum, a gear, etc., and therefore the relevant details are not described herein.

The connecting cable 14 has a first segment 142 and a second segment 144 which are connected together. The first segment 142 is exposed out of the reeling member 124, and goes into the housing 122 through the bore 122a; the second segment 144 winds around the reeling member 124. An end of the second segment 144 can be pulled out of the case 10 through the opening 104′.

The first connector 16 and the second connector 18 are electrically connected to an end of the first segment 142 and an end of the second segment 144 of the connecting cable 14 respectively. In the first preferred embodiment, the first connector 16 is provided in the case 10 with a portion thereof extending out through the opening 104. The first connector 16 and the second connector 18 are connectors of two different types. In the first preferred embodiment, the first connector 16 is a USB Type-A connector, and the second connector 18 is a lightning connector. However, this is not a limitation of the present invention, the first and the second connectors 16, 18 can be of other types in other embodiments, such as USB Micro-B, Type-C, etc. In practice, the first connector 16 and the second connector 18 can be connectors of the same type.

The wireless power transmission module 20 includes an induction coil 22 and a conversion circuit 24, wherein the induction coil 22 receives an external electromagnetic energy, converts the electromagnetic energy into an electrical signal, and outputs the electrical signal to the conversion circuit 24; the conversion circuit 24 converts the electrical signal into power to be outputted. In practice, the electromagnetic energy can be received by magnetic induction or magnetic coupling. In the first preferred embodiment, the induction coil 22 and the conversion circuit 24 are respectively disposed on a first substrate 26 and a second substrate 28. The first substrate 26 is disposed in the recess 106, and therefore the induction coil 22 is in the recess 106 as well. The second substrate 28 is located in the case 10, wherein the first connector 16 is directly connected to the second substrate 28. The induction coil 22 is connected to two conductive members, which are two wires 222 as an example in the first preferred embodiment. The wires 222 pass through the perforation 108 of the case 10 to be electrically connected to the conversion circuit 24 disposed on the second substrate 28, wherein at least one of the wires 222 is electrically connected to the conversion circuit 24 through a protective member 29. In order not to damage the conversion circuit 24, the protective member 29 prevents the electrical signal outputted by the induction coil 22 from being transmitted to the conversion circuit 24 when the electrical signal is found abnormal. In practice, the protective member 29 can be a fuse, a temperature impedance element (e.g., a positive temperature coefficient thermistor), an integrated circuit which is capable of detecting whether the electrical signal outputted by the induction coil 22 is abnormal and preventing the electrical signal from being transmitted to the conversion circuit 24, or a transistor collocating with a detection circuit and a MCU, wherein the detection circuit detects the electrical signal, and the MCU executes program to control the transistor to prevent the electrical signal from being transmitted to the conversion circuit 24 when abnormality is found.

In practice, the first connector 16 can be disposed outside the case 10, and is electrically connected to the conversion circuit 24 disposed on the second substrate 28 and the connecting cable 14 through another connecting cable (not shown), wherein the first connector 16 and the opening 104 are separated by a certain distance, and therefore the first connector 16 can be plugged into a slot of an electrical device which has denser slot arrangement. In addition to the aforementioned wires 222, the conductive members can also be conductive pins engaged with a pin base, or electrically connected to a substrate in a point-to-point way.

The first connector 16, the first segment 142 of the connecting cable 14, and the conversion circuit 24 can be electrically connected through conductive wires, or alternatively, the second substrate 28 can have conductive circuit provided thereon to make the first connector 16, the connecting cable 14, and the conversion circuit 24 electrically connect to each other. It is important that the connecting point where the conversion circuit 24 and the first segment 142 of the connecting cable 14 are connected together is located outside the reeling member 124. Whereby, the connecting point would not be pulled into the reeling member 124, and therefore the conversion circuit 24 and the connecting cable 14 would not fall off. In practice, the induction coil 22 and the conversion circuit 24 can be disposed on the first substrate 26 together, while the conversion circuit 24 can be electrically connected to the first segment 142 of the connecting cable 14 through wires or other means of electrical connection (e.g., a conductive circuit provided on the first substrate 26 or a pad).

In addition, the reeling device 1 further includes a cover 32 engaged to the case 10 to cover the recess 106. In this way, the induction coil 22 would not exposed out. In practice, as long as the induction coil 22 is able to sense electromagnetic energy, the induction coil 22 and the conversion circuit 24 can be disposed on the first substrate 26 together, and the first substrate 26 can be located within the case 10. In such a case, the cover 32 may be omitted, and the recess 106 of the case 10 may not be necessary as well.

In the first preferred embodiment, the second substrate 28 further includes a reverse cut-off element, which is a diode 30 as an example, provided thereon. The diode 30 cuts off current when it flows reversely, wherein an anode of the diode 30 is connected to a positive electricity output of the conversion circuit 24, and a cathode thereof is connected to a wire of positive electricity of the connecting cable 14. Whereby, when the first connector 16 is connected to a power source, current from the connecting cable 14 is prevented from flowing to the conversion circuit 24 by the diode 30 prevents, which avoids damaging the conversion circuit 24. Of course, the reverse cut-off element can be also provided on the conversion circuit 24 directly.

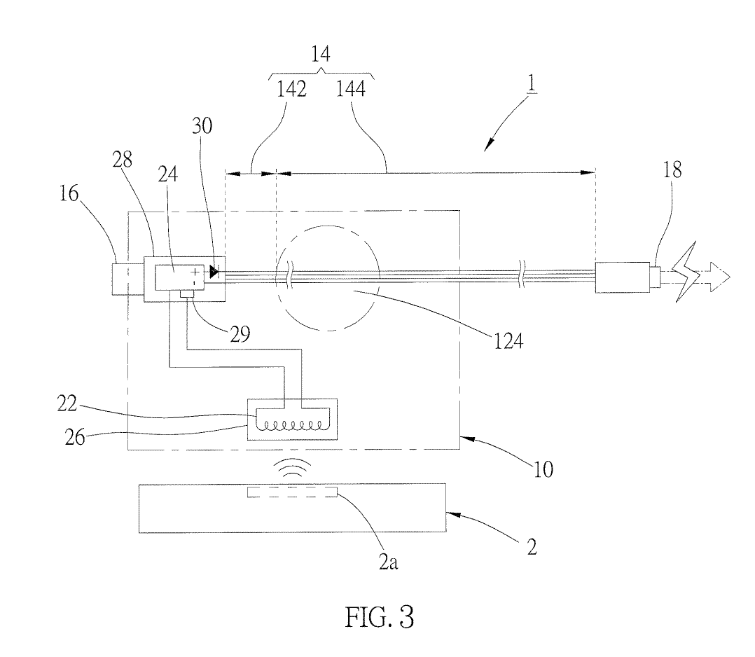

As shown in FIG. 3, when at use, the reeling device 1 provided in the present invention is placed on an external wireless charging device 2, and the induction coil 22 faces an induction coil 2a of the wireless charging device 2. The induction coil 2a of the wireless charging device 2 transmits electromagnetic energy to be received by the induction coil 22 of the reeling device 1, and then the conversion circuit 24 outputs power to the connecting cable 14. Therefore, once the second connector 18 is connected to an electrical device (e.g., a mobile phone) which requires power, the electrical device can be charged in this way.

With the aforementioned reeling device 1, a user can freely choose different power sources for the second connector 18. If the wireless charging device 2 is available, a user may choose to generate electricity by using the wireless power transmission module 20 to receive electromagnetic energy. On the contrary, if the wireless charging device 2 is not available, the first connector 16 can be still connected to a power source to transmit power to the second connector 18.

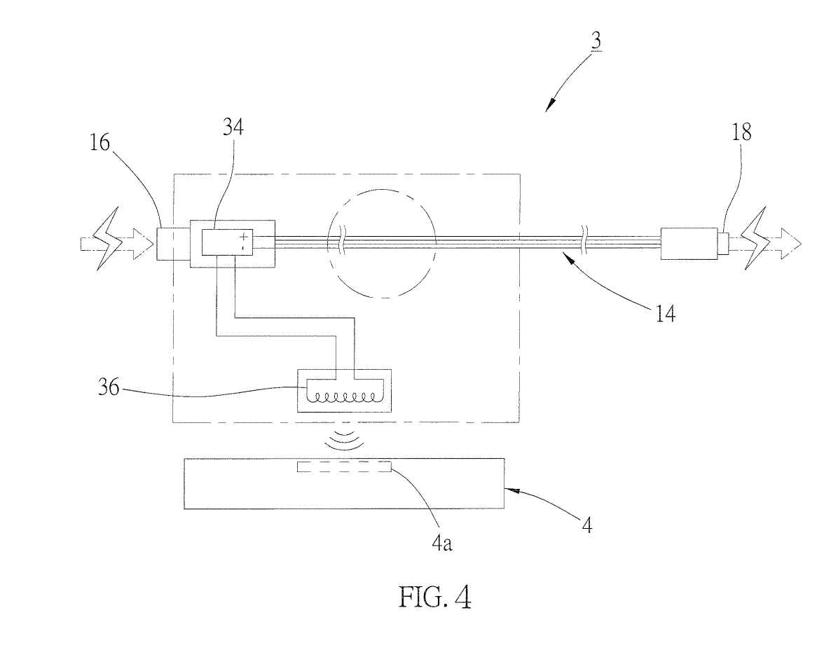

As shown in FIG. 4, a reeling device 3 of a second preferred embodiment of the present invention approximately has the same structure with the aforementioned first preferred embodiment, except that the conversion circuit 34 of the second preferred embodiment receives power from the connecting cable 14, and converts the power into an electrical signal to be transmitted to the induction coil 36; the induction coil 36 then converts the electrical signal into electromagnetic energy.

When at use, the first connector 16 is connected to a power source to provide power to the conversion circuit 34, and electromagnetic energy is generated through the induction coil 36. An electrical device 4 having wireless charging function can be charged by being placed near the induction coil 4a, for an induction coil 4a of the electrical device 4 can receive the electromagnetic energy.

In other words, the reeling device 3 can be used as a wireless charging device, which is capable of charging electrical devices having wireless charging function. At the same time, the second connector 18 can also output power.

In summary, the reeling device provided in the present invention combines the functions of a conventional cable reel and a wireless charging module, and therefore not only can be used as an extension cord for signals or power, but also can transmit power wirelessly, which makes the reeling device versatile in its usage.

It must be pointed out that the embodiments described above are only some preferred embodiments of the present invention. All equivalent structures which employ the concepts disclosed in this specification and the appended claims should fall within the scope of the present invention.

What is claimed is:

1. A reeling device, comprising:
a reeling member;
a connecting cable winding around the reeling member;
a first connector;
a second connector, wherein two ends of the connecting cable are electrically connected to one of the first connector and the second connector respectively;
a case having an opening communicating an inside thereof, wherein the reeling member is received in the case, and one of the ends of the connecting cable extends out of the case through the opening by exerting a pulling force; and
a wireless power transmission module comprising an induction coil and a conversion circuit, wherein the induction coil is provided in the case, and the conversion circuit is electrically connected to the induction coil and the connecting cable respectively.

2. The reeling device of claim 1, wherein a recess is formed on an external surface of the case; the induction coil is disposed in the recess.

3. The reeling device of claim 2, wherein the case has a perforation communicating the inside of the case and the recess; the conversion circuit is located in the case; the conversion circuit and the induction coil are electrically connected through a plurality of conductive members, and the conductive members passing through the perforation.

4. The reeling device of claim 3, further comprising a first substrate and a second substrate, wherein the first substrate is disposed in the recess of the case, and the induction coil is disposed on the first substrate; the second substrate is provided in the case, and the conversion circuit is disposed on the second substrate; the first connector is connected to the second substrate; the connecting cable comprises a first segment and a second segment which are connected together, wherein the first segment is located outside of the reeling member, and is electrically connected to the first connector and the conversion circuit; the second segment winds around the reeling member, and is electrically connected to the second connector.

5. The reeling device of claim 2, further comprising a substrate disposed in the recess, wherein the induction coil and the conversion circuit are disposed on the substrate; the connecting cable comprises a first segment and a second segment which are connected together, wherein the first segment is located outside of the reeling member, and is electrically connected to the first connector and the conversion circuit; the second segment winds around the reeling member, and is electrically connected to the second connector.

6. The reeling device of claim 2, further comprising a cover engaged to the case to cover the recess.

7. The reeling device of claim 1, further comprising a substrate disposed in the recess, wherein the induction coil and the conversion circuit are disposed on the substrate; the connecting cable comprises a first segment and a second segment which are connected together, wherein the first segment is located outside of the reeling member, and is electrically connected to the first connector and the conversion circuit; the second segment winds around the reeling member, and is electrically connected to the second connector.

8. The reeling device of claim 1, wherein a connecting point where the conversion circuit and the connecting cable are connected is located outside the reeling member, and the connecting point never goes into the reeling member.

9. The reeling device of claim 1, wherein the induction coil receives an external electromagnetic energy, converts the electromagnetic energy into an electrical signal, and transmits the electrical signal to the conversion circuit; the conversion circuit converts the electrical signal into power to be transmitted to the connecting cable.

10. The reeling device of claim 9, wherein the wireless power transmission module comprises a reverse cut-off element, which cuts off current when the current flows reversely; the conversion circuit is electrically connected to the connecting cable through the reverse cut-off element.

11. The reeling device of claim 9, wherein the wireless power transmission module comprises a protective member electrically connected to a position between the induction coil and the conversion circuit; the protective member prevents the electrical signal from being transmitted to the conversion circuit when the electrical signal is abnormal.

12. The reeling device of claim 1, wherein the conversion circuit receives power from the connecting cable, and converts the power into an electrical signal to be transmitted to the induction coil; the induction coil converts the electrical signal into electromagnetic energy.
